(19) United States
(12) Patent Application Publication
(10) Pub. No.: US 2018/0295777 A1
(43) Pub. Date: Oct. 18, 2018

(54) HEADER WITH A CROP DIVIDER DISC

(71) Applicant: AGCO Corporation, Duluth, GA (US)

(72) Inventors: Dane Austin Mosel, Hesston, KS (US); Brendon C. Nafziger, Canton, KS (US); Jarred M. Jennings, Hesston, KS (US)

(21) Appl. No.: 15/953,932

(22) Filed: Apr. 16, 2018

Related U.S. Application Data
(60) Provisional application No. 62/486,496, filed on Apr. 18, 2017.

(51) Int. Cl. A01D 57/22; A01D 34/66

(52) U.S. Cl. CPC A01D 57/22; A01D 34/66

(57) ABSTRACT

A header has a frame with opposing, upright side panel assemblies, a transverse cutting bar disposed between the upright side panel assemblies, and plural rotary cutters. Each of the upright side panel assemblies has a bearing mounted to an outboard side of the upright side panel assembly with a single, circular disc freely-rotatable about the bearing.

### CROSS REFERENCE TO RELATED APPLICATION

This application claims the benefit of U.S. Provisional Application No. 62/486,496 filed Apr. 18, 2017, which is hereby incorporated by reference in its entirety.

### BACKGROUND OF THE INVENTION

### Field of Invention

The present disclosure is generally related to harvesting equipment, and, more particularly, harvesting headers.

### Description of Related Art

Harvesting headers, such as rotary headers, are used on self-propelled and pull-type harvesting equipment, such as windrowers. Rotary headers generally comprise plural, transverse-mounted, rotating, knife-edged cutting assemblies that sever standing crop that is fed to one or more sets of mower conditioner rolls to condition the severed crop into a swath or windrow on the field.

Tall, stalky or vine-like crops can be particularly difficult to harvest and condition because stalks from one row may become entangled with stalks in an adjacent row, resulting in crop hair-pinning and build-up of crop at and around a front-edge of end panels of the header. Such conditions occur in downed or lodged uncut crop as well as when cutting into swathed or windrowed cut crop while cutting a partial header width.

### BRIEF SUMMARY OF THE INVENTION

Briefly stated, one aspect of the invention is directed to a header, comprising: a frame comprising opposing, upright side panel assemblies; a transverse cutting bar disposed between the upright side panel assemblies and comprising plural rotary cutters; and at each of the upright side panel assemblies: a bearing mounted to an outboard side of the upright side panel assembly; and a single, circular disc freely-rotatable about the bearing.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example harvesting machine with coupled header on which an embodiment of a crop divider disc may be implemented.

FIG. 2 is a schematic diagram illustrating a fragmentary, left-side elevation view of a header using an embodiment of a crop divider disc.

FIG. 3 is a schematic diagram illustrating a fragmentary, rear elevation view of a header using an embodiment of a crop divider disc.

FIG. 4 is a schematic diagram illustrating a fragmentary, overhead plan view of a header using an embodiment of a crop divider disc.

FIG. 5 is a flow diagram that illustrates an embodiment of a crop dividing method.

Corresponding reference characters indicate corresponding parts throughout the views of the drawings.

### DESCRIPTION OF EXAMPLE EMBODIMENTS

Certain embodiments of header comprising a crop divider disc, system, and associated method are disclosed that provide a solution to a problem of crop hair pinning and/or build-up at or around the sides of a header for certain crops and/or crop conditions. In one embodiment, a crop divider disc is located at opposing, outboard sides of respective side panel assemblies of a harvesting header, and comprises a circular, serrated disc mounted in, and freely rotatable about, a bearing attached to each end panel assembly. For instance, the harvesting header may be a rotary cutter hay header. The circular disc and bearing are positioned on each end panel assembly such that when the header is in an operating position, the circular disc is at an optimal crop-engaging height regardless of header tilt. Each circular disc radially engages and restrains the crop to the ground, and releases the crop positioned outboard of the end panel assembly as the harvesting machine moves forward. Any crop that is inboard of the end panel assembly is severed and fed into the header by the cutter assembly (e.g., rotary cutters) and converging components of the header.

Digressing briefly, long stalks, particularly in forage applications where stalks may be approximately six to ten feet in length, may be rooted inboard of the header yet overlap into the uncut area outside of the header. These stalks may be caught by the forward edge of one or more of the side panel assemblies of the header, resulting in a hair-pinning of the stalks about the edge and/or causing the crop flow into the header to be interrupted. The flow interruption may result in poor machine performance and/or undesired windrow or swath formation. Some known solutions include mounting, to an inboard side of each side panel, a powered disc with serrations and an adjacent mounting plate with triangular projections, whereby a shearing effect is implemented between the rotation of the powered disc and the static mounting plate. Other known solutions include using plural wheels or discs mounted to bearings on an outboard side of the end panels that are disposed above the ground and, in cooperation with a curved forward edge, feed the crop into a cutter bar. In contrast to these known solutions, certain embodiments of a crop divider disc provides a simpler, energy-efficient approach for avoiding hair-pinning and build-up by utilizing a single disc that is freely rotatable about bearings (and hence unpowered) mounted to each side panel assembly and positioned on the header relative to ground to pinch the crop and enable the rotary cutter assembly to sever the crop.

Having summarized certain features of a crop divider disc of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, the focus is on a header that is coupled to a harvesting machine embodied as a self-propelled windrower, though it should be appreciated that towed windrowers or other harvesting machines may be used in some embodiments. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the harvesting machine looking forwardly.

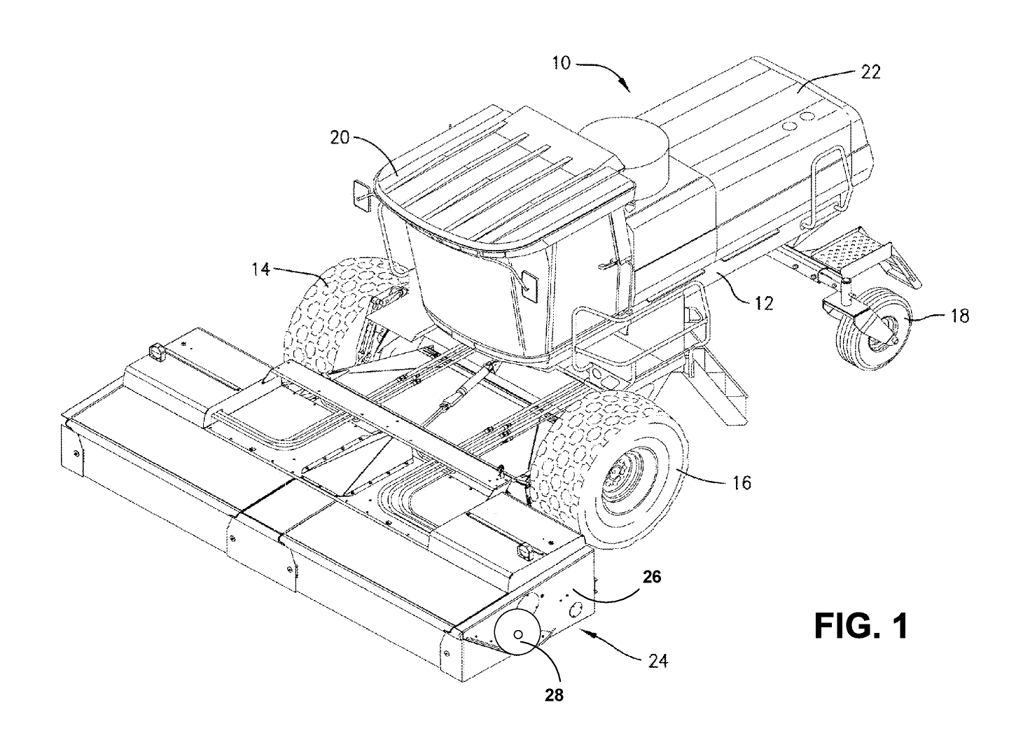

Referring now to FIG. 1, shown is an example harvesting machine 10 embodied as a windrower (also known as a swather or generally, harvester) in which all or at least a portion of certain embodiments of a crop divider disc may be employed. One having ordinary skill in the art should appreciate in the context of the present disclosure that the windrower design and operation shown in, and described in association with, FIG. 1 is merely illustrative, and that other designs and/or variations in operation are contemplated to be within the scope of the disclosure. The windrower 10 shown in FIG. 1 is self-propelled, and is operable to mow and collect standing crop in the field, condition the cut material as it moves through the machine to improve its drying characteristics, and then return the conditioned material to the field in a windrow or swath. The windrower 10 includes a chassis or frame 12 supported by a pair of front drive wheels 14, 16 and a pair of rear caster wheels 18 (only the left rear caster wheel 18 being illustrated) for movement across a field to be harvested. The frame 12 carries a cab 20, within which an operator controls operation of the windrower 10, and a rearwardly spaced compartment 22 that houses a power source (not shown) such as an internal combustion engine. A harvesting header 24 is supported on the front of the frame 12 in a manner well understood by those skilled in the art.

The header 24 may include a rotary cutter bed or assembly (enclosed in the header 24 and not shown in FIG. 1) across the front of the machine that serves as a mechanism to sever standing crops as the windrower 10 advances across a field. In one embodiment, the rotary cutter bed comprises a transverse cutting bar with plural rotary cutters attached thereto. The header 24 may also comprise a discharge opening behind the cutter bed which serves as an inlet to one or more sets of conditioner rolls. As the operation of a windrower is well-known to those having ordinary skill in the art, further discussion is omitted here for the sake of brevity. Note that some embodiments may use different header designs.

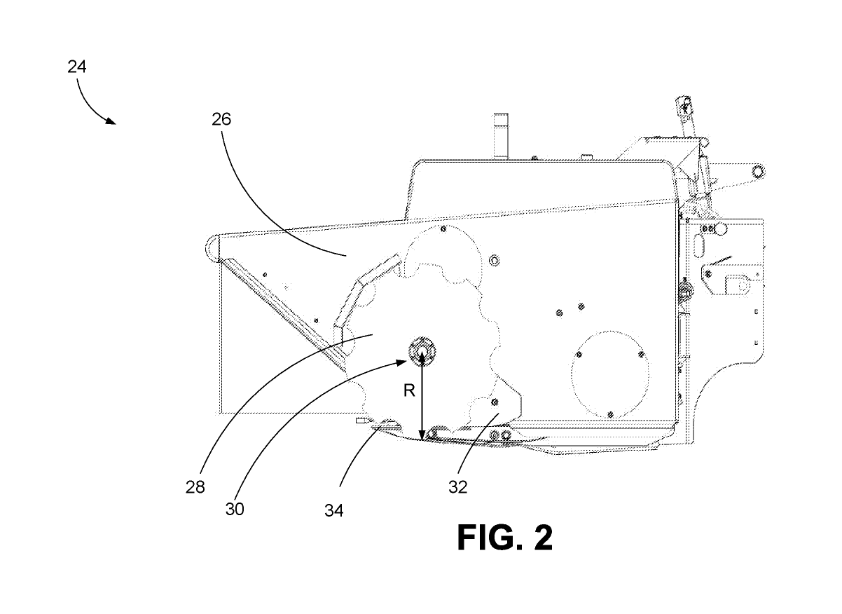

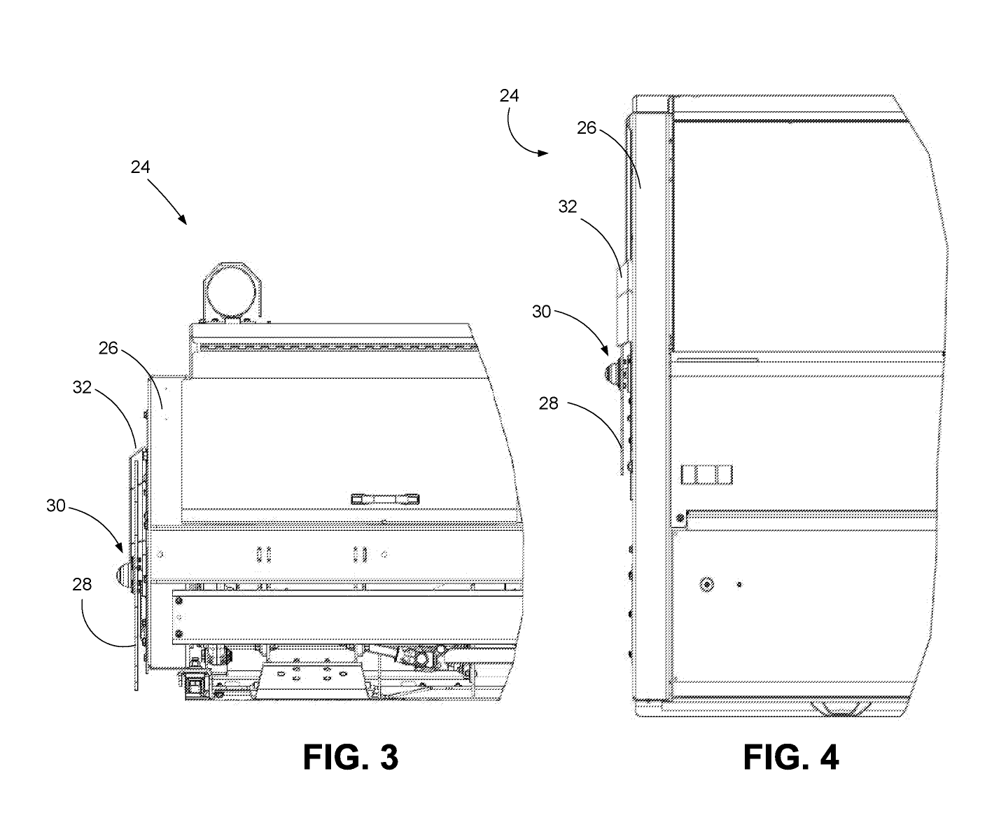

Referring now to FIGS. 2-4 (with continued reference to FIG. 1), the header comprises opposing side panel assemblies 26 (the left-side shown in FIG. 2). Disposed on an outboard side of each opposing side panel assembly 26 of the header 24 is a single crop divider disc 28 (a smooth periphery embodiment shown in FIG. 1, whereas a serrated embodiment is shown in FIG. 2). The crop divider disc 28 is mounted to bearing 30 that comprises part of a well-known hub assembly. The crop divider disc 28 is freely rotatable about the bearing 30. The bearing 30 may comprise any one of a variety of known bearings, including single-row (ball) bearings, double-row bearings, tapered bearings, etc. In one embodiment, the side panel assembly 26 comprises a mounting bracket 32, to which the bearing 30 is mounted in a manner similar to any of known hub and bearing assemblies. For instance, the crop divider disc 28 comprises a shaft that is journaled into the bearings 30, and the bearings 30 are slidably inserted onto a threaded stud that is secured (e.g., welded) along the backside of the stud to the mounting bracket 32. In some embodiments, the mounting bracket 32 may be omitted, or in some embodiments, the manner of mounting the bearing 30 and disc 28 may be achieved according to other known attachment mechanisms.

In one embodiment, the disc 28 is positioned from top-bottom on the side panel assembly 26 such that a radius, R, of the disc 28 extends between, and ends respectively at, the center of the bearing 30 (or similarly, center of a shaft of the disc 28) and a contact point between a periphery of the disc and the ground. In other words, the distance between the center of the disc 28 (or the center of the bearing 30) and ground is R, and enables crop to be pinched between a periphery of the disc 28 and the ground on the outboard side of the header 24 during forward movement of the harvesting machine 10 to enable a rotary cutter assembly 34 to sever the stalk at the inbound side of the header 24. By locating the disc 28 such that one end of the radius is equal to the ground/disc periphery contact point, a pivot point is established (at the point of contact between the periphery of the disc 28 and the ground) that enables the stalk to be pinched between the periphery of the disc 28 and the ground, regardless of header tilt, and cut by the rotary cutter assembly 34.

In one embodiment, the center of the disc 28 (or likewise, bearing center) is positioned fore and aft along the side panel assembly 26 forward of a rear plane of the cutting members of the rotary cutter assembly 34. For instance, for a rotary cutter assembly 34, the rearward-most point of a knife of each rotary cutter comprises the rear plane. In some embodiments, the respective rotational axis of each of the rotary cutters collectively comprise a plane that is aligned or substantially aligned fore and aft with the center of the disc 28.

In one embodiment, the disc 28 comprises a steel, serrated disc. In some embodiments, the periphery of the disc 28 may be sharp yet smooth, or of other configurations (e.g., sawtooth, jagged, etc.) in some embodiments.

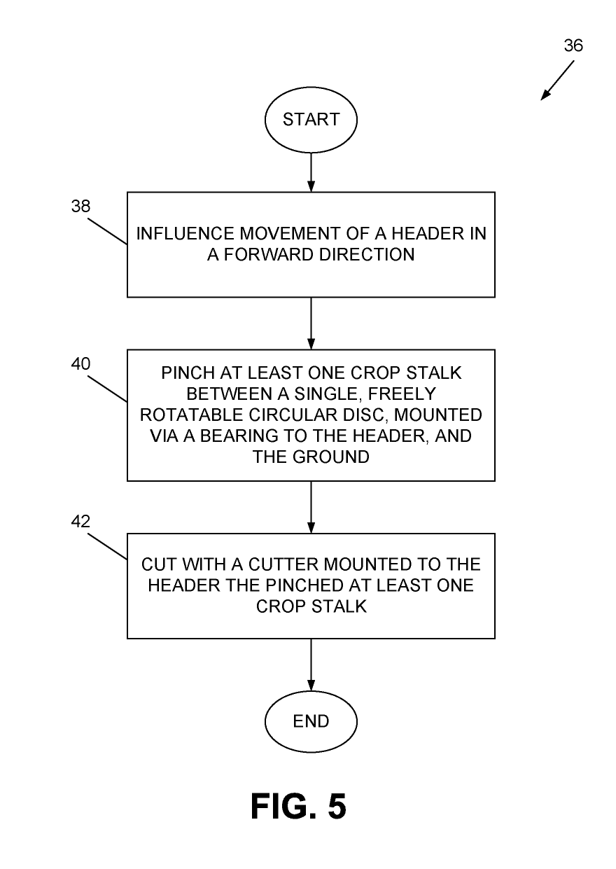

In view of the above description, it should be appreciated that one embodiment of a method for cutting crop, denoted as method 36 and illustrated in FIG. 5, comprises influencing movement of a header in a forward direction (38); pinching at least one crop stalk between a single, freely rotatable circular disc, mounted via a bearing to the header, and the ground (40); and cutting with a cutter mounted to the header the pinched at least one crop stalk (42).

Any process descriptions or blocks in flow diagrams should be understood as representing steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present invention, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A header, comprising:
a frame comprising opposing, upright side panel assemblies;
a transverse cutting bar disposed between the upright side panel assemblies and comprising plural rotary cutters; and
at each of the upright side panel assemblies:
a bearing mounted to an outboard side of the upright side panel assembly; and
a single, circular disc freely-rotatable about the bearing.

2. The header of claim 1, wherein each of the upright side panel assemblies comprises a mounting bracket, the bearing mounted to the mounting bracket.

3. The header of claim 1, wherein the circular disc comprises a serrated, circular disc comprised of steel.

4. The header of claim 1, wherein the circular disc comprises a radius, the radius extending between, and ending respectively at, the bearing and the ground.

5. The header of claim 4, wherein a point on a periphery of the circular disc that contacts the ground comprises a pivot point, wherein regardless of a tilt angle of the header, the pivot point maintains contact with the ground.

6. The header of claim 1, wherein at each of the upright side panel assemblies, one side of the circular disc is adjacent the upright side panel and the opposing side of the circular disc is adjacent no other structure.

7. The header of claim 1, wherein the circular disc is unpowered at all times.

8. A method for cutting crop, comprising:
influencing movement of a header in a forward direction;
pinching at least one crop stalk between a single, freely rotatable circular disc, mounted via a bearing to the header, and the ground; and
cutting with a cutter mounted to the header the pinched at least one crop stalk.

9. The method of claim 8, wherein the pinching is implemented at an outboard side of the header.

10. The method of claim 8, wherein the cutting is implemented at an inboard side of the header.

11. The method of claim 8, wherein the cutting is implemented with a rotary cutter.

12. The method of claim 8, wherein the influencing is based on the header mounted to a towed harvesting machine.

13. The method of claim 8, wherein the influencing is based on the header mounted to a self-propelled harvesting machine.

14. The method of claim 8, wherein the circular disc is serrated.

15. A system, comprising:
a header, the header comprising:
a frame comprising opposing, upright side panel assemblies;
a cutter assembly; and
a single, circular disc freely-rotatable about a bearing coupled to an outboard side of each of the upright side panel assemblies.

16. The system of claim 15, wherein each of the upright side panel assemblies comprises a mounting bracket mounted thereon.

17. The system of claim 16, wherein the bearing is coupled to the mounting bracket.

18. The system of claim 17, wherein the circular disc comprises a radius, the radius extending between, and respectively ending at, the bearing and the ground.

19. The system of claim 18, wherein a point on a periphery of the circular disc that contacts the ground comprises a pivot point, wherein regardless of a tilt angle of the header, the pivot point maintains contact with the ground.

20. The system of claim 15, further comprising a harvesting machine coupled to the header.
